(19) United States
(12) Patent Application Publication
(10) Pub. No.: US 2025/0207585 A1
(43) Pub. Date: Jun. 26, 2025

(54) GEAR PUMP OR GEAR MOTOR

(71) Applicant: DAIKIN INDUSTRIES, LTD., Osaka (JP)

(72) Inventor: Koji WATARIDACHI, Osaka (JP)

(21) Appl. No.: 19/076,848

(22) Filed: Mar. 11, 2025

Related U.S. Application Data
(63) Continuation of application No. PCT/JP2023/026141, filed on Jul. 14, 2023.

(30) Foreign Application Priority Data
Sep. 28, 2022 (JP) 2022-154718

(51) Int. Cl. F04C 15/06; F04C 2/18

(52) U.S. Cl. CPC F04C 15/06; F04C 2/18; F05C 2201/0448

(57) ABSTRACT

A gear pump or gear motor includes a drive gear and a driven gear that mesh with each other, and a side plate arranged to be opposed to the drive and driven gears. One of the drive and driven gears is a first gear. A suction passage, a discharge passage, a mesh area, and a rotation trajectory area are arranged on a rotation trajectory of teeth of the first gear in a rotation direction of the teeth of the first gear in order of the suction passage, the rotation trajectory area, the discharge passage, and the mesh area. The side plate includes a first opening opposed to the mesh area, a second opening opposed to the rotation trajectory area, and a feed passage communicating with the first opening and the second opening.

### CROSS-REFERENCE TO RELATED APPLICATIONS

This is a continuation of International Application No. PCT/JP2023/026141 filed on Jul. 14, 2023, which claims priority under 35 U.S.C. § 119 (a) to Patent Application No. 2022-154718, filed in Japan on Sep. 28, 2022, all of which are hereby expressly incorporated by reference into the present application.

### BACKGROUND

### Technical Field

The present disclosure relates to a gear pump or a gear motor.

### Background Information

Japanese Unexamined Patent Publication No. 2017-223122 discloses a gear pump or a gear motor. The gear pump or the gear motor described in Japanese Unexamined Patent Publication No. 2017-223122 includes gears (a drive gear and a driven gear) and a side plate opposed to the drive gear and the driven gear. On the rotation trajectory of the gear, there is a mesh area in which the teeth of the drive gear and the teeth of the driven gear mesh with each other.

### SUMMARY

A first aspect is directed to a gear pump or a gear motor. The gear pump or gear motor includes a drive gear and a driven gear that mesh with each other, and a side plate arranged to be opposed to the drive gear and the driven gear. One of the drive gear and the driven gear is a first gear. A suction passage through which a fluid flows, a discharge passage through which a fluid having a higher pressure than the fluid flowing through the suction passage flows, a mesh area in which the drive gear and the driven gear mesh with each other, and a rotation trajectory area are arranged on a rotation trajectory of teeth of the first gear in a rotation direction of the teeth of the first gear in order of the suction passage, the rotation trajectory area, the discharge passage, and the mesh area. The side plate includes a first opening opposed to the mesh area, a second opening opposed to the rotation trajectory area, and a feed passage communicating with the first opening and the second opening.

### BRIEF DESCRIPTION OF THE DRAWINGS

FIG. 1 is a schematic general configuration diagram of a gear pump or a gear motor according to an embodiment.

FIG. 2 is a plan view of a gear.

FIG. 3 is a plan view showing a closed area.

FIG. 4 is a cross-sectional view of a side plate.

FIG. 5 is a plan view of a first side plate.

FIG. 6 is a bottom view of the first side plate.

FIG. 7 is a plan view of a second side plate.

FIG. 8 is a bottom view of the second side plate.

FIG. 9 is a plan view showing a gear of a typical gear pump or gear motor.

FIG. 10 shows a relationship between the rotational angle of the gear of the typical gear pump or gear motor and the pressure of a fluid in a specific tooth space.

FIG. 11 shows a relationship between the rotational angle of the gear of the gear pump or gear motor according to this embodiment and the pressure of a fluid in a specific tooth space.

FIG. 12 is a plan view of a gear.

FIG. 13 is a plan view of a gear.

FIG. 14 is a plan view of a gear.

### DETAILED DESCRIPTION OF EMBODIMENT(S)

Embodiments of the present disclosure will be described in detail below with reference to the drawings. The present disclosure is not limited to the embodiments shown below, and various changes can be made within the scope without departing from the technical concept of the present disclosure. Since each of the drawings is intended to illustrate the present disclosure conceptually, dimensions, ratios, or numbers may be exaggerated or simplified as necessary for the sake of ease of understanding.

Exemplary embodiments will be described in detail below based on the drawings.

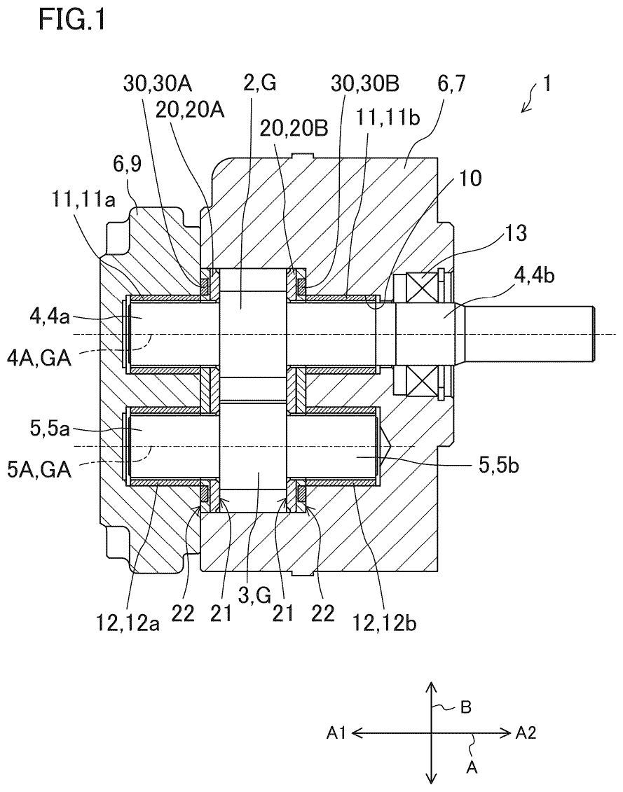

With reference to FIG. 1, a gear pump or gear motor (1) according to an embodiment of present invention will be described. FIG. 1 is a cross-sectional view of the gear pump or gear motor (1). In the following, the gear pump or gear motor (1) is referred to as a gear pump (1). The gear pump (1) sucks a fluid (e.g., hydraulic oil) supplied from a tank storing the fluid, raises the pressure of the fluid, and then discharges the fluid to supply the fluid to hydraulic equipment.

### General Configuration

As shown in FIG. 1, the gear pump (1) includes a drive gear (2) and a driven gear (3) that mesh with each other, a drive shaft (4) and a driven shaft (5) that support the drive gear (2) and the driven gear (3), respectively, and a casing (6) that houses the drive gear (2), the driven gear (3), the drive shaft (4), and the driven shaft (5). The gear pump (1) according to this embodiment sucks a fluid supplied from a tank storing the fluid, raises the pressure of the fluid, and then discharges the fluid to supply the fluid to hydraulic equipment.

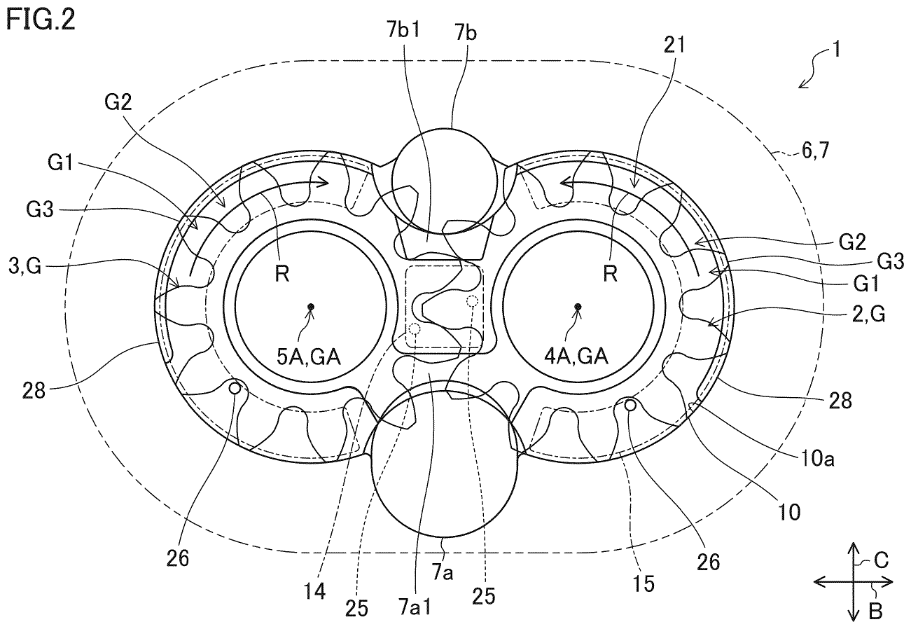

Hereinafter, a direction parallel to the axis (4A) of the drive shaft (4) and the axis (5A) of the driven shaft (5) may be referred to as a “first direction (A)”. Out of the directions perpendicular to the first direction (A), a direction parallel to the direction in which the drive gear (2) and the driven gear (3) are arranged may be referred to as a “second direction (B)”. A direction perpendicular to the first direction (A) and the second direction (B) may be referred to as a “third direction (C)” (see FIG. 2).

The casing (6) includes a body (7) and a cover (9) to be fixed to the body (7). The cover (9) is disposed at one side (A1) of the casing (6) in the first direction (A). The internal space (10) of the casing (6) extends from the internal space of the body (7) to the internal space of the cover (9).

In the internal space (10) of the casing (6), the drive gear (2), the drive shaft (4) to be fixed to or integral with the drive gear (2), the driven gear (3), and the driven shaft (5) to be fixed to or integral with the driven gear (3) are arranged. The axis (4A) of the drive shaft (4) and the axis (5A) of the driven shaft (5) are parallel to each other.

The drive shaft (4) extends through the center of the drive gear (2) along the axis (4A) of the drive shaft (4). The drive shaft (4) rotates about the axis (4A), together with the drive gear (2). The driven shaft (5) extends through the center of the driven gear (3) along the axis (5A) of the driven shaft (5). The driven shaft (5) rotates about the axis (5A), together with the driven gear (3).

The drive gear (2) and the driven gear (3) mesh with each other. When the drive gear (2) rotates, the drive gear (2) transmits power to the driven gear (3) at a point where the drive gear (2) and the driven gear (3) mesh with each other, thereby rotating the driven gear (3). As a result, the drive gear (2) and the driven gear (3) rotate together.

As shown in FIGS. 1 and 2, the drive gear (2) and the driven gear (3) are each configured as a spur gear and are arranged in the internal space (10) inside the casing (6).

The drive shaft (4) includes a first drive shaft (4a) at one side (A1) of the drive gear (2) in the first direction (A), and a second drive shaft (4b) at the other side (A2) of the drive gear (2) in the first direction (A). A driving means (e.g., a prime mover) is connected to the second drive shaft (4b). The driven shaft (5) includes a first driven shaft (5a) at one side (A1) of the driven gear (3) in the first direction (A), and a second driven shaft (5b) at the other side (A2) of the driven gear (3) in the first direction (A).

In the gear pump (1), the drive gear (2) and the driven gear (3) are housed in the internal space (10), while meshing with each other, and tooth tips thereof are in sliding contact with the inner peripheral surface of the internal space (10). Accordingly, the drive gear (2) and the driven gear (3) rotate, while meshing with each other in the internal space (10) of the casing (6). The drive gear (2) and the driven gear (3) are in sliding contact with the inner peripheral surface of the internal space (10) of the casing (6) while rotating, thereby dividing the internal space (10) into a low-pressure area and a high-pressure area.

The gear pump (1) includes a drive bearing (11) that rotatably supports the drive shaft (4), and a driven bearing (12) that rotatably supports the driven shaft (5). The drive bearing (11) includes a first drive bearing (11a) that rotatably supports the first drive shaft (4a), and a second drive bearing (11b) that rotatably supports the second drive shaft (4b). The driven bearing (12) includes a first driven bearing (12a) that rotatably supports the first driven shaft (5a), and a second driven bearing (12b) that rotatably supports the second driven shaft (5b). The first drive bearing (11a), the second drive bearing (11b), the first driven bearing (12a), and the second driven bearing (12b) each include a sliding bearing, for example.

In the internal space (10) of the casing (6), an oil seal (13) is provided between the casing (6) and the drive shaft (4). The oil seal (13) is a rubber member, for example. The oil seal (13) is located at the other side (A2) of the second drive bearing (11b) in the first direction (A).

The gear pump (1) includes a pair of side plates (20) and a pair of sealing members (30). The side plates (20) in pair are disposed to sandwich the drive gear (2) and the driven gear (3) from both sides of the first direction (A). The side plates (20) in pair are each disposed to be opposed to the drive gear (2) and the driven gear (3). The side plates (20) are each sandwiched between the drive gear (2) and the casing (6) and between the driven gear (3) and the casing (6). The drive shaft (4) and the driven shaft (5) are inserted through each of the side plates (20) in pair.

One side plate (20A) of the side plates (20) in pair is disposed on one side (A1) of the drive gear (2) and the driven gear (3) in the first direction (A). The other side plate (20B) of the side plates (20) in pair is disposed on the other side (A2) of the drive gear (2) and the driven gear (3) in the first direction (A). One of the sealing members (30) in pair, that is, a sealing member (30A) is attached to the side plate (20A). The other sealing member (30B) of the sealing members (30) in pair is attached to the side plate (20B).

As shown in FIG. 2, in the gear pump (1), the casing (6) includes a suction passage (7a) communicating with the low-pressure area of the internal space (10), and a discharge passage (7b) communicating with the high-pressure area of the internal space (10). The suction passage (7a) and the discharge passage (7b) are arranged at a distance in the third direction (C). The fluid flowing through the discharge passage (7b) has a higher pressure than the fluid flowing through the suction passage (7a).

Hereinafter, either one of the drive gear (2) or the driven gear (3) may be referred to as a “gear (G)”. The axis of the gear (G) may be referred to as an “axis (GA)”. The axis (GA) represents the axis (4A) of either one of the drive shaft (4) or the axis (5A) of the driven shaft (5).

The gear (G) includes teeth (G1). The teeth (G1) are arranged in the rotation direction (R) of the gear (G). The teeth (G1) rotate about the axis (GA). A tooth space (G2), which is a space, is formed between each adjacent teeth (G1) in pair.

On the rotation trajectory of the teeth (G1) of the gear (G), there are the suction passage (7a), the discharge passage (7b), a mesh area (14), and a rotation trajectory area (15).

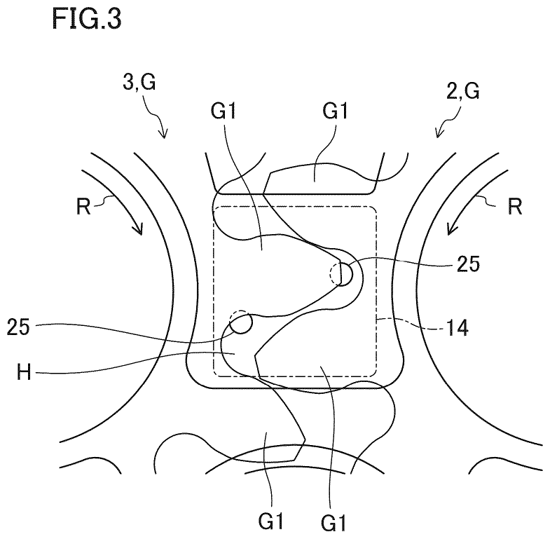

The mesh area (14) represents an area in which the drive gear (2) and the driven gear (3) mesh with each other. In the mesh area (14), the drive gear (2) and the driven gear (3) mesh with each other to form a closed area (H) surrounded by the teeth (G1) of the drive gear (2) and the teeth (G1) of the driven gear (3) (see FIG. 3).

As shown in FIG. 2, the rotation trajectory area (15) is an area of the trajectory of the teeth (G1) formed while the gear (G) is rotating and located between the suction passage (7a) and the discharge passage (7b). In the rotation trajectory area (15), a process for raising the pressure of the fluid in the tooth spaces (G2) is performed, while the gear (G) is rotating.

The suction passage (7a), the discharge passage (7b), the mesh area (14), and the rotation trajectory area (15) are arranged in the rotation direction of the teeth (G1) of the gear (G) in the order of the suction passage (7a), the rotation trajectory area (15), the discharge passage (7b), and the mesh area (14). The rotation direction (R) represents the direction in which the gear (G) (i.e., the teeth (G1) of the gear (G)) rotates during operation of the gear pump (1). The operation of the gear pump (1) means that the rotation of the gear (G) causes the process of feeding the fluid through the discharge passage (7b), the rotation trajectory area (15), and the discharge passage (7b) to the hydraulic equipment.

When the teeth (G1) of the gear (G) rotate within the rotation trajectory area (15), the tips (G3) of the gear (G) slide on the wall surface (10a) of the internal space (10). As a result, the tooth spaces (G2) are closed.

In the gear pump (1), a pipe from a tank for storing a fluid is connected to the suction passage (7a) of the casing (6). A pipe heading to the hydraulic equipment is connected to the discharge passage (7b). When the drive shaft (4) of the drive gear (2) is rotated by a drive means (e.g., a prime mover, not shown), the driven gear (3) meshing with the drive gear (2) rotates in the rotation direction (R), together with the drive gear (2). Accordingly, the fluid in the space surrounded by the inner peripheral surface of the internal space (10) and the tooth spaces (G2) is transferred toward the discharge passage (7b) in the rotation direction (R) by the rotation of the gear (G). As a result, the discharge passage (7b) serves a high-pressure side and the suction passage (7a) serves as a low-pressure side with the mesh area (14) regarded as a boundary.

When the suction passage (7a) has a negative pressure due to the fluid transferred to the discharge passage (7b), the fluid in the tank is sucked through the pipe and the suction passage (7a) into the low-pressure side of the internal space (10). The fluid in the space surrounded by the inner peripheral surface of the internal space (10) and the tooth spaces (G2) is transferred from the suction passage (7a) in the rotation direction (R) by the rotation of the gear (G). The fluid is pressurized to have a high pressure when passing through the rotation trajectory area (15), and is supplied to the discharge passage (7b). The fluid supplied to the discharge passage (7b) is supplied through a pipe to the hydraulic equipment.

### Side Plate

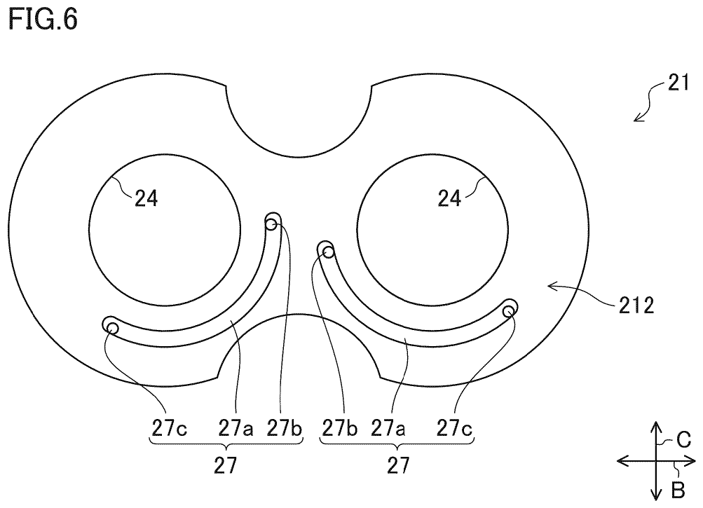

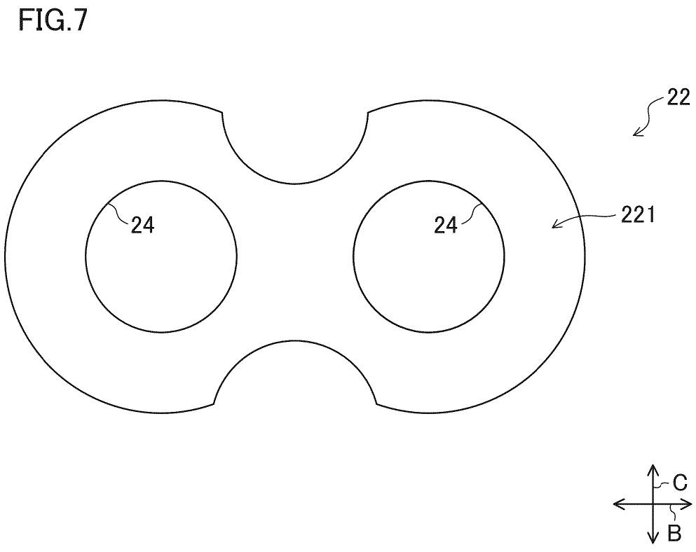

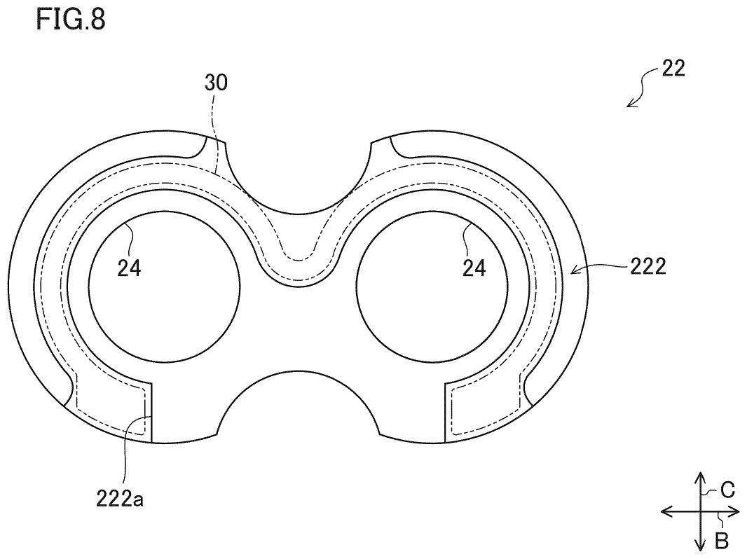

As shown in FIGS. 1 and 4 to 8, a side plate (20) has a substantially 8-shape. The side plate (20) includes a first side plate (21) and a second side plate (22). The side plate (20) has a shape in which the first side plate (21) and the second side plate (22) are stacked on each other.

The first side plate (21) includes a pair of arc portions (21a) and a central portion (21b). The arc portions (21a) in pair are each formed in an arc shape. The central portion (21b) is located between the arc portions (21a) in pair and is continuous between the arc portions (21a) in pair.

The outer surface of the first side plate (21) includes an opposed surface (211) and a first mating surface (212). The opposed surface (211) is opposed to the gear (G). The first mating surface (212) is located on the back of the opposed surface (211).

The outer surface of the second side plate (22) includes a second mating surface (221) and a back surface (222). The second mating surface (221) is opposed to the first mating surface (212) of the first side plate (21) and is stacked on the first mating surface (212). The back surface (222) is located on the back of the second mating surface (221).

The first side plate (21) and the second side plate (22) constitute the pair of side plates (20). The side plate (20) is configured with the back surface (222) located on the back of the opposed surface (211).

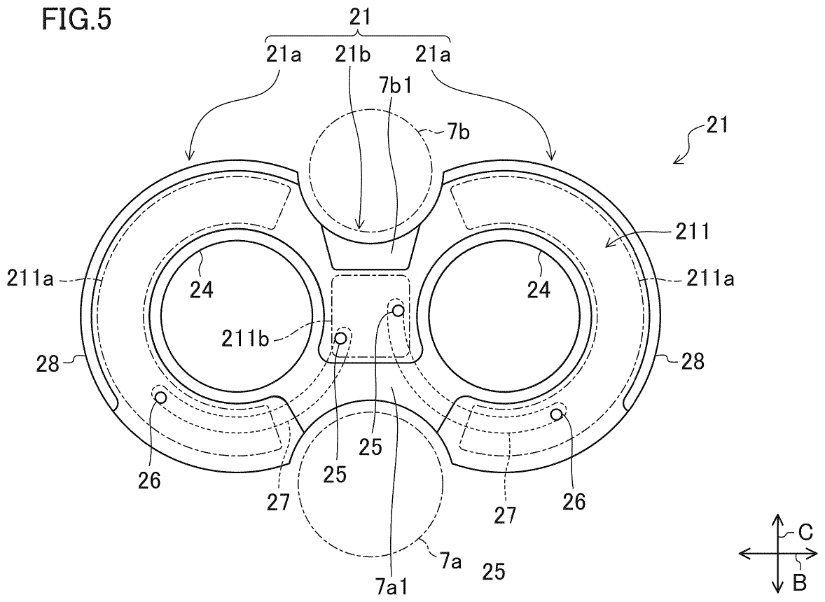

The side plate (20) includes a pair of through holes (24) penetrating the side plate (20) in the first direction (A). The through holes (24) in pair are arranged at a distance in the second direction (B). The pair of through holes (24) corresponds to the pair of arc portions (21a) (see FIG. 5). The through holes (24) in pair are each provided in the corresponding arc portion (21a). The drive shaft (4) is inserted into one of the through holes (24) in pair, and the driven shaft (5) is inserted into the other through hole.

A sealing groove (222a) in which one of the sealing members (30) is mounted is provided in the back surface (222) of the side plate (20). The sealing member (30) is a rubber member, for example. The sealing groove (222a) has a shape obtained by recessing the back surface (222).

The opposed surface (211) of the first side plate (21) includes a first opening (25), a second opening (26), and a third opening (28).

The first opening (25) is opposed to the mesh area (14). The second opening (26) is opposed to the rotation trajectory area (15).

A feed passage (27) communicates with the first opening (25) and the second opening (26). The feed passage (27) includes a first passage section (27a), a second passage section (27b), and a third passage section (27c).

The first passage section (27a) is a space left between the first side plate (21) and the second side plate (22). In this embodiment, a groove is formed in the first mating surface (212) of the first side plate (21), the second mating surface (221) of the second side plate (22) is formed into a flat surface, and the first passage section (27a) is formed by a space between the groove of the first mating surface (212) and the second mating surface (221). Alternatively, a groove may be formed in the second mating surface (221) of the second side plate (22), the first mating surface (212) of the first side plate (21) may be formed into a flat surface, and the first passage section (27a) may be formed by a space between the groove of the second mating surface (221) and the first side plate (21). Alternatively, grooves may be formed in the first mating surface (212) and the second mating surface (221), and the first passage section (27a) may be formed by a space surrounded by the groove of the first mating surface (212) and the groove of the second mating surface (221).

The second passage section (27b) is a hole penetrating the first side plate (21) in the first direction (A). The second passage section (27b) communicates with the first opening (25) and the first passage section (27a).

The third passage section (27c) is a hole penetrating the first side plate (21) in the first direction (A). The third passage section (27c) communicates with the second opening (26) and the first passage section (27a).

The central portion (21b) has two first openings (25). The arc portions (21a) in air each have the second opening (26). The two first openings (25) correspond to the respective second openings (26) in pair. The feed passage (27) extends from each of the two first openings (25) toward the corresponding second opening (26). A pair of the series of groove structures each including the first opening (25), the second opening (26), and the feed passage (27) is provided.

The third opening (28) is opposed to the rotation trajectory area (15). The third opening (28) is connected to the discharge passage (7b). The third opening (28) has a shape extending in an arc shape from the discharge passage (7b) toward the suction passage (7a) along the outer periphery of the first side plate (21), while being opposed to the rotation trajectory area (15). The third opening (28) is closer to the head of the rotation direction (R) of the gear (G) than the second opening (26) is. The third opening (28) is open in each of the arc portions (21a) in pair.

As shown in FIG. 5, the opposed surface (211) includes a first opposed surface (211a) opposed to the rotation trajectory area (15) (see FIG. 2), a second opposed surface (211b) opposed to the mesh area (14) (see FIG. 2), a suction-side clearance groove (7a1), and a discharge-side clearance groove (7b1). The first opposed surface (211a) is provided in each of the arc portions (21a) in pair. The second opposed surface (211b) is provided in the central portion (21b). The suction-side clearance groove (7a1) is provided downstream of the second opposed surface (211b) in the rotation direction (R), and constitutes a part of the suction passage (7a). The discharge-side clearance groove (7b1) is provided upstream of the second opposed surface (211b) in the rotation direction (R), and constitutes a part of the discharge passage (7b). The suction-side clearance groove (7a1) and the discharge-side clearance groove (7b1) have a shape recessed with respect to the first opposed surface (211a) and the second opposed surface (211b).

### Change in Pressure of Fluid in Tooth Space

As shown in FIG. 2, when passing over the suction passage (7a) while the gear (G) is rotating in the rotation direction (R), the tooth spaces (G2) communicate with the suction passage (7a), whereby the fluid in the tooth spaces (G2) has a low pressure. Once the tooth spaces (G2) further rotate and are opposed to the second opening (26), the fluid in the closed area (H) (see FIG. 3) is fed through the first opening (25) and the feed passage (27) to the tooth spaces (G2), thereby raising the pressure of the fluid in the tooth spaces (G2). Once the tooth spaces (G2) further rotate and are opposed to the third opening (28), the high-pressure fluid in the discharge passage (7b) is supplied through the third opening (28) to the tooth spaces (G2). When the high-pressure fluid from the third opening (28) is supplied to the tooth spaces (G2), the pressure of the fluid in the tooth spaces (G2) further rises to be high. The tooth spaces (G2) that have passed through the third opening (28) rotate toward the discharge passage (7b), while containing the high-pressure fluid.

With the high-pressure fluid contained in the tooth spaces (G2), the gear (G) rotates. The high-pressure fluid contained in the tooth spaces (G2) then applies a pressure to the side plate (20) in directions away from the gear (G). As a result, the wear of the side plate (20) in contact with the gear (G) can be reduced.

### Test

The present inventors conducted a test for comparing the performance of the gear pump (1) according to this embodiment to the performance of a typical gear pump (100).

Test Result of Typical Gear Pump

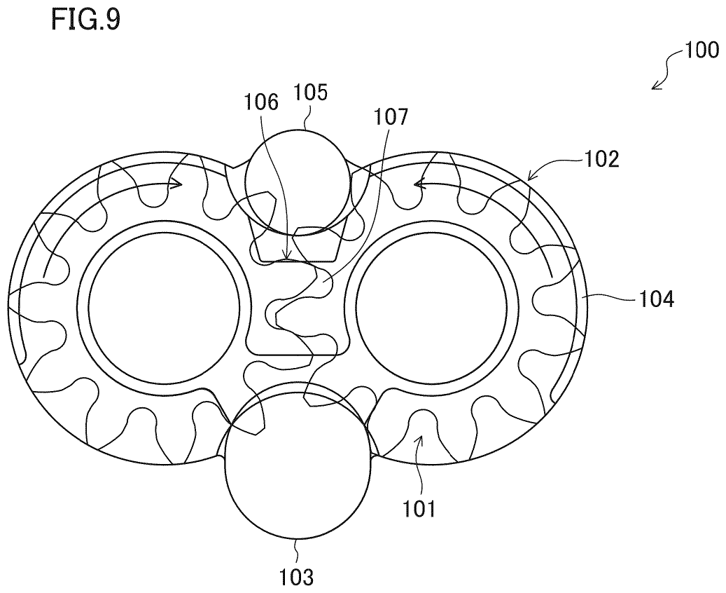

As shown in FIG. 9, the typical gear pump (i.e., gear pump or gear motor) (100) is different from the gear pump (1) according to this embodiment in including none of the first opening (25), the second opening (26), and the feed passage (27). With respect to the typical gear pump, a specific tooth space (101) of tooth spaces will be described.

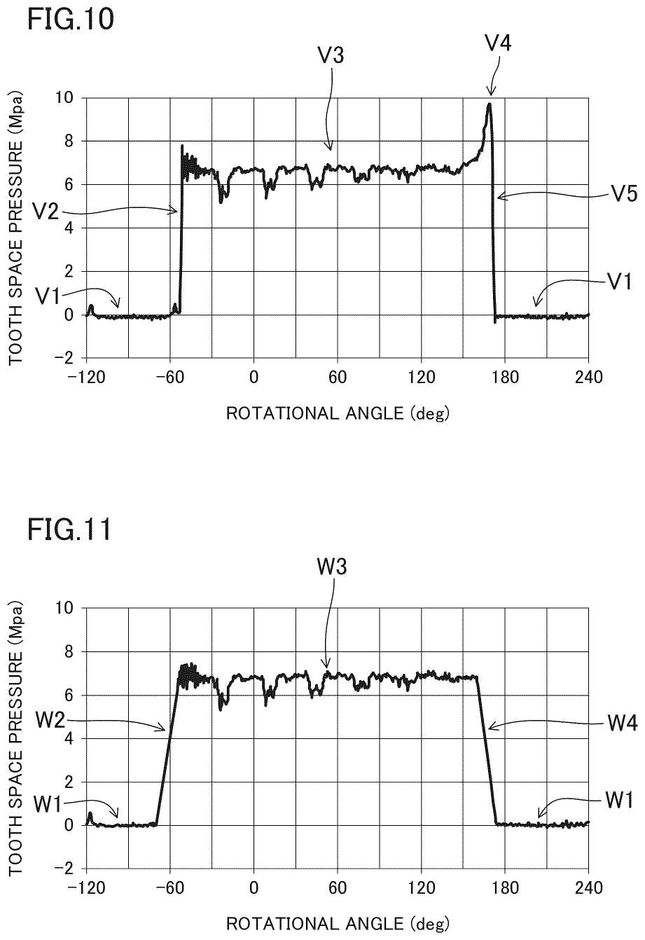

FIG. 10 shows a relationship between a rotational angle of a gear (102) (i.e., either one of a drive gear or a driven gear) of the typical gear pump (100) and the pressure of a fluid in the specific tooth space (101). The specific tooth space (101) represents any one of the tooth spaces (101) of the gear (102).

As shown in FIGS. 9 and 10, in the typical gear pump (100), with the specific tooth space (101) located between a suction passage (103) and the opening (104), the fluid in the specific tooth space (101) has a low pressure (see the arrow (V1) in FIG. 10). When the specific tooth space (101) is opposed to the opening (104), the high-pressure fluid in the discharge passage (7b) is supplied through the opening (104) into the specific tooth space (101), thereby rapidly raising the pressure of the fluid in the specific tooth space (101) (see the arrow (V2) in FIG. 10). The fluid in the specific tooth space (101) has a high pressure from when the specific tooth space (101) is opposed to an opening (104) until when the specific tooth space (101) reaches a mesh area (106) (see the arrow (V3) in FIG. 10). When the specific tooth space (101) reaches the mesh area (106), a closed area (107) is formed in the specific tooth space (101). The fluid in the specific tooth space (101) is then compressed in the closed area (107), and the pressure of the fluid in the specific tooth space (101) further rises (see the arrow (V4) in FIG. 10). With the pressure of the fluid in the specific tooth space (101) further raised, the closed area (107) formed by the specific tooth space (101) passes through the mesh area (106) and communicates with the suction passage (103). The high-pressure fluid in the specific tooth space (101) is then rapidly fed to the suction side (i.e., toward the suction passage (103)) due to the differential pressure from the fluid in the suction passage (103). Thus, the pressure of the fluid in the specific tooth space (101) rapidly decreases (see the arrow (V5) in FIG. 10). The rapid change in the pressure of the fluid in the tooth space (101) may cause an increase in vibration or noise. At the moment when the closed area (107) communicates with the suction side, the high-pressure fluid compressed in the closed area (107) flows into the suction side, thereby causing cavitation. As a result, components of the gear pump (100) may be damaged.

### Test Results of Gear Pump of This Embodiment

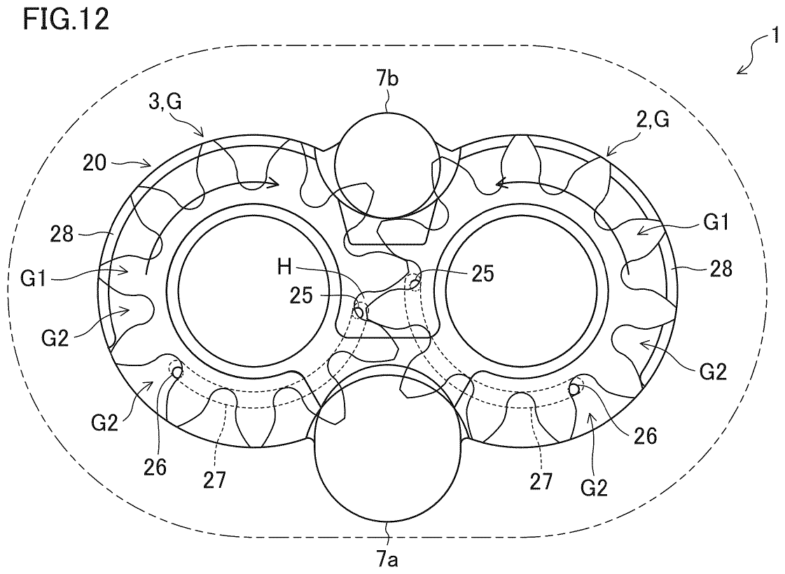

FIG. 11 shows a relationship between the rotational angle of the gear (G) of the gear pump (1) according to this embodiment and the pressure of a fluid in a specific tooth space (G2). The specific tooth space (G2) represents any one of the tooth spaces (G2) of the gear (G).

As shown in FIGS. 2 and 11, in the gear pump (1) according to this embodiment, with the specific tooth space (G2) located between the suction passage (7a) and the second opening (26), the fluid in the specific tooth space (101) has a low pressure (see the arrow (W1) in FIG. 11). When the specific tooth space (G2) is opposed to the second opening (26), the fluid in the closed area (H) (see FIG. 3) is supplied through the first opening (25), the feed passage (27) (see FIG. 5), and the second opening (26) to the specific tooth space (G2), thereby raising the pressure of the fluid in the specific tooth space (G2) (see the arrow (W2) in FIG. 11). When the specific tooth space (G2) further rotates and is opposed to the third opening (28), the high-pressure fluid in the discharge passage (7b) is supplied through the third opening (28) into the specific tooth space (G2), thereby further raising the pressure of the fluid in the specific tooth space (G2) (see the arrow (W2) in FIG. 11). In the gear pump (1) according to this embodiment, the fluid from the second opening (26) and the fluid from the third opening (28) are fed into the specific tooth space (G2) in a stepwise manner, thereby reducing a rapid rise of the pressure of the fluid in the specific tooth space (G2) and raising the pressure gradually or in a stepwise manner as indicated by the arrow (W2) in FIG. 11.

In the gear pump (1) according to this embodiment, the fluid in the specific tooth space (G2) has a high pressure from when the specific tooth space (G2) is opposed to the third opening (28) until when the specific tooth space (G2) reaches the mesh area (14) (see the arrow (W3) in FIG. 11). When the specific tooth space (G2) reaches the mesh area (14), the closed area (H) (see FIG. 3) is formed in the specific tooth space (G2). The fluid in the closed area (H) is however fed through the first opening (25), the feed passage (27) (see FIG. 5), and the second opening (26) to another tooth space (G2). Accordingly, when the closed area (H) passes through the mesh area (14), the pressure of the fluid in the specific tooth space (G2) forming the closed area (H) gradually decreases (see the arrow (W4) in FIG. 11). When the closed area (H) formed by the specific tooth space (G2) passes through the mesh area (14) and communicates with the suction side (i.e., the suction passage (H)), the fluid in the specific tooth space (G2) is fed to the suction side due to the differential pressure from the fluid in the suction passage (7a), whereby the pressure of the fluid in the specific tooth space (G2) further decreases (see the arrow (W4) in FIG. 11). In the gear pump (1) according to this embodiment, when the closed area (H) passes through the mesh area (106), the fluid in the specific tooth space (G2) forming the closed area (H) is fed from the first opening (25) to another tooth space (G2). The pressure of the fluid in the specific tooth space (G2) thus decreases to some extent. As a result, as indicated by the arrow (W4) in FIG. 11, even when the closed area (H) formed by the specific tooth space (G2) passes through the mesh area (106) and communicates with the suction side, a rapid drop of the pressure of the fluid in the specific tooth space (G2) is reduced, and the pressure decreases gradually or in a stepwise manner.

As described above, the gear pump (1) according to this embodiment can reduce a rapid change in the pressure of the fluid in the tooth spaces (G2) between the teeth, as compared to the typical gear pump (100). As a result, vibration or noise generated in the gear pump (1) can be reduced. In addition, the flow of a high-pressure fluid from the tooth spaces (G2) (i.e., the closed area (H)) immediately after the fluid has passed through the mesh area (106), into the suction side can be reduced. This can reduce the damage to the components of the gear pump (1) by cavitation.

### Advantages

As described above, the side plate (20) includes the first opening (25) opposed to the mesh area (14), the second opening (26) opposed to the rotation trajectory area (15), and the feed passage (27) communicating with the first opening (25) and the second opening (26). Accordingly, the fluid whose pressure has become higher in the closed area (H) is fed from the first opening (25) through the feed passage (27) and the second opening (26) to the rotation trajectory area (15), whereby the pressure of the fluid in the closed area (H) decreases before the closed area (H) passes through the mesh area (14). Accordingly, even when the fluid in the closed area (H) is supplied to the suction-side clearance groove (7a1) after the closed area (H) has passed through the mesh area (14), a rapid change in the pressure of the fluid in the tooth spaces (G2) can be reduced. As a result, vibration or noise generated in the gear pump (1) can be reduced. The damage to the components of the gear pump (1) by cavitation can also be reduced.

The third opening (28) is closer to the head of the rotation direction (R) of the gear (G) than the second opening (26) is. The fluid in the closed area (H) is supplied through the second opening (26) into the tooth spaces (G2), and then the fluid in the discharge passage (7b) is supplied through the third opening (28) into the tooth spaces (G2), so that the pressure of the fluid in the tooth spaces (G2) can be raised gradually or in a stepwise manner. As a result, a rapid change in the pressure of the fluid in the tooth spaces (G2) can be reduced, which can reduce the vibration or noise generated in the gear pump or gear motor.

With an increase in speed of the rotation of the gear (G), an abnormally high pressure may be generated in the fluid in the closed area (107). The abnormally high pressure can be reduced by setting the opening area of the first opening (25) and the volume of the feed passage (27) in accordance with the magnitude of the abnormally high pressure. By feeding the fluid in the closed area (H) to the tooth spaces (G2) in the rotation trajectory area (15) through the feed passage (27), the fluid can be supplied to the tooth spaces (G2) in the rotation trajectory area (15). Thus, the fluid can be more efficiently transported to the tooth spaces (G2) in the rotation trajectory area (15).

While the embodiments and the variations thereof have been described above, it will be understood that various changes in form and details may be made without departing from the spirit and scope of the claims (e.g., (1) to (5) below). The embodiments, the variations, and the other embodiments may be combined and replaced with each other without deteriorating intended functions of the present disclosure.

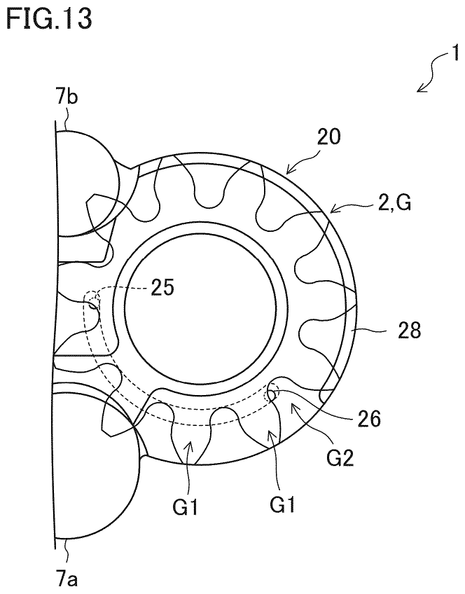

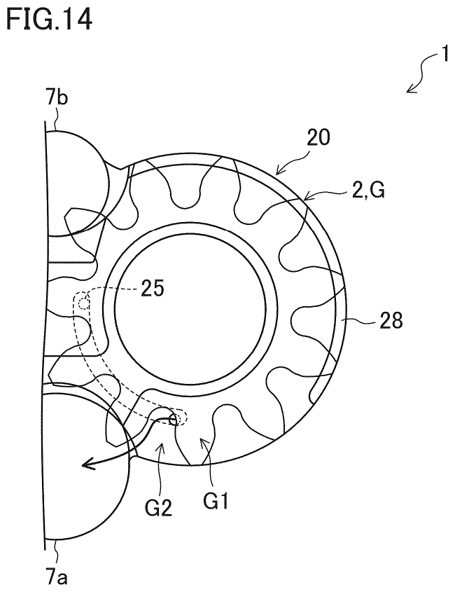

(1) It is preferable that with the third opening (28) opposed to any one of tooth spaces (G2) of the gear (G), the second opening (26) is opposed to an area of the rotation trajectory area (15) different from an area in which the one of tooth spaces (G2) is opposed to the third opening (28). In other words, it is preferable that the second opening (26) and the third opening (28) are not opposed to the same tooth space (G2) at the same time as shown in FIG. 12, and it is not preferable that the openings are opposed the same tooth space (G2) at the same time as shown in FIG. 13. With this configuration, as shown in FIG. 13, the second opening (26) and the third opening (28) are opposed to the same tooth space (G2) at the same time, and the fluid from the second opening (26) and the fluid from the third opening (28) are supplied to the tooth space (G2) at the same time. This can reduce a rapid change in the pressure of the fluid in the tooth spaces (G2).

(2) As shown in FIG. 12, it is preferable that with the first opening (25) opposed to the closed area (H), the second opening (26) and the third opening (28) are opposed to different ones of the tooth spaces (G2). This configuration allows effective process of supplying the fluid from the second opening (26) and the fluid from the third opening (28) to different tooth spaces (G2).

(3) FIG. 14 shows that, with the second opening (26) opposed to any one of the tooth spaces (G2), the tooth spaces (G2) opposed to the second opening (26) and the suction passage (7a) are not partitioned by at least one of the teeth (G1) and communicate with each other. In this configuration, even when the fluid in the closed area (H) is supplied from the second opening (26) into the tooth spaces (G2), the fluid is fed to the suction passage (7a). The pressure of the fluid in the tooth spaces (G2) thus does not rise and becomes equal to the pressure of the fluid of the suction passage (7a) (i.e., low). In this case, the tooth spaces (G2) further rotate and are opposed to the third opening (28), and a high-pressure fluid is supplied from the third opening (28) to the tooth spaces (G2), which may cause the problem of a rapid rise of the pressure of the fluid in the tooth spaces (G2) from low to high.

In order to reduce the problem, as shown in FIG. 12, with the second opening (26) opposed to any one of the tooth spaces (G2), the tooth spaces (G2) opposed to the second opening (26) and the suction passage (7a) are partitioned by at least one of the teeth (G1) so as not to communicate with each other. In this configuration, when the fluid in the closed area (H) is supplied from the second opening (26) into the tooth spaces (G2), the teeth (G1) reduce the fluid fed to the suction passage (7a), and the fluid is held in the tooth spaces (G2). Accordingly, the state is maintained in which the fluid in the tooth spaces (G2) has a higher pressure than the fluid in the suction passage (7a), which is regarded as a “first increase”. From this state, the tooth spaces (G2) further rotate, and the high-pressure fluid is supplied from the third opening (28) to the tooth spaces (G2), thereby further raising the pressure of the fluid in the tooth spaces (G2), which is regarded as a “second increase”. By effectively performing the process of raising the pressure of the fluid in the tooth spaces (G2) gradually or in a stepwise manner through the first rise and the second rise, a rapid rise of the pressure of the fluid in the tooth spaces (G2) can be reduced.

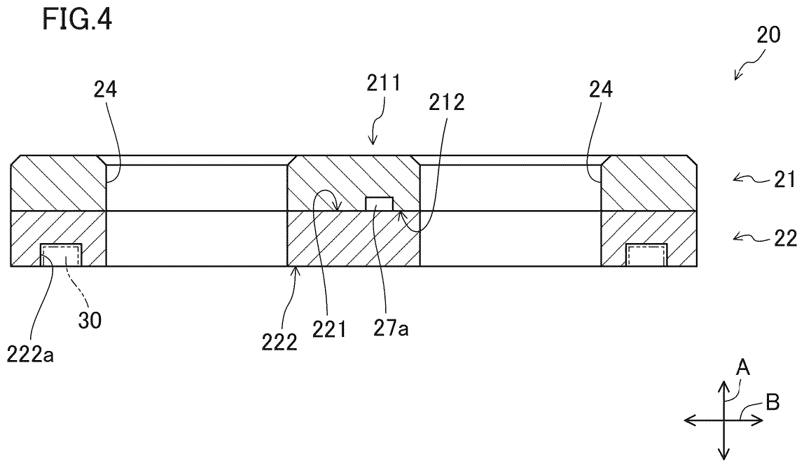

(4) As shown in FIGS. 1 and 4, the first side plate (21) may contain a copper alloy. This can improve the slidability of the gear (G) with respect to the first side plate (21), while the gear (G) is rotating. The second side plate (22) may include a damping steel plate or a damping alloy. This configuration can effectively reduce the vibration of the side plate (20).

(5) As shown in FIGS. 1 and 4, in this embodiment, the side plate (20) is formed of two plate members (i.e., the first side plate (21) and the second side plate (22)), but the present invention is not limited thereto. The side plate (20) may be formed of one plate member or three or more plate members.

(6) As shown in FIG. 2, the third opening (28) according to this embodiment has a shape extending in an arc shape from the discharge passage (7b) toward the suction passage (7a) along the outer periphery of the side plate (20), and is thus connected to the discharge passage (7b). However, the present invention is not limited thereto, and the shape of the third opening (28) is not limited. The third opening (28) may be, for example, an opening that does not communicate with the discharge passage (7b) and is spaced apart from the discharge passage (7b) so as to be opposed to the rotation trajectory area (15). In this case, the side plate (20) is provided with a passage by a hole provided in the side plate (20) and/or a groove in the arc-shaped side of the side plate (20). When the passage communicates with the third opening (28) and the discharge passage (7b), the third opening (28) and the discharge passage (7b) are connected to each other through the passage.

As described above, the present disclosure is useful for a gear pump or a gear motor.

1. A gear pump or gear motor comprising:
a drive gear and a driven gear that mesh with each other; and
a side plate arranged to be opposed to the drive gear and the driven gear,
one of the drive gear and the driven gear being a first gear,
a suction passage through which a fluid flows, a discharge passage through which a fluid having a higher pressure than the fluid flowing through the suction passage flows, a mesh area in which the drive gear and the driven gear mesh with each other, and a rotation trajectory area being arranged on a rotation trajectory of teeth of the first gear in a rotation direction of the teeth of the first gear in order of the suction passage, the rotation trajectory area, the discharge passage, and the mesh area, and
the side plate including
a first opening opposed to the mesh area,
a second opening opposed to the rotation trajectory area, and
a feed passage communicating with the first opening and the second opening.

2. The gear pump or gear motor of claim 1, wherein
the side plate further includes a third opening opposed to the rotation trajectory area and arranged to be connected to the discharge passage, and
the third opening is closer to a head of a rotation direction of the first gear than the second opening.

3. The gear pump or gear motor of claim 2, wherein
with the third opening opposed to any one of tooth spaces of the first gear, the second opening is opposed to a part of the rotation trajectory area different from a part in which the one of tooth spaces is opposed to the third opening.

4. The gear pump or gear motor of claim 2, wherein
the mesh area includes a closed area surrounded by the teeth of the drive gear and the teeth of the driven gear, and
with the first opening opposed to the closed area, the second opening and the third opening are opposed to different tooth spaces of the first gear.

5. The gear pump or gear motor of claim 1, wherein
with the second opening opposed to any one of tooth spaces of the first gear, the one of tooth spaces opposed to the second opening and the suction passage are partitioned by at least one of the teeth.

6. The gear pump or gear motor of claim 1, wherein
the side plate includes
a first side plate to be opposed to the first gear, and
a second side plate configured to be fixed to the first side plate,
an opposed surface of an outer surface of the first side plate opposed to the first gear includes the first opening and the second opening, and
the feed passage includes
a first passage section between the first side plate and the second side plate,
a second passage section provided in the first side plate and communicating with the first passage section and the first opening, and
a third passage section provided in the first side plate and communicating with the first passage section and the second opening.

7. The gear pump or gear motor of claim 6, wherein
the second side plate includes a damping steel plate or a damping alloy.
